(19) United States
(12) Patent Application Publication
(10) Pub. No.: US 2007/0109924 A1
(43) Pub. Date: May 17, 2007

(54) Optical pickup

(75) Inventors: Kazuhiro Takahashi, Osaka (JP); Yuichi Kamioka, Osaka (JP); Atsushi Ikeda, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/598,068

(22) Filed: Nov. 13, 2006

(30) Foreign Application Priority Data
Nov. 15, 2005 (JP) 2005-329702

(51) Int. Cl. G11B 7/00

(52) U.S. Cl. 369/44.23; 369/44.37; 369/112.02

(57) ABSTRACT

An optical pickup includes a light source, an objective lens for condensing a light beam emitted from the light source on a disk, a hologram element for splitting the light beam reflected by the disk, a photo detector for receiving the split light beam, a holding element for holding the objective lens and the hologram element, and an actuator for driving the holding element, the objective lens and the hologram element as one unit to shift in a tracking direction.

This application is based on Japanese Patent Application No. 2005-329702 filed on Nov. 15, 2005, the contents of which are hereby incorporated by reference.

### BACKGROUND OF THE INVENTION

1. Field of the Invention

The present invention relates to a structure of an optical pickup for reproducing and recording information on an optical disk.

2. Description of Related Art

A disk drive for reproducing and recording information on an optical disk such as a CD, a DVD or a Blu-ray Disc (hereinafter referred to as BD) performs a tracking servo that is a control for making a beam spot follow a track on a disk.

An optical pickup that is provided to a conventional disk drive is disclosed in JP-A-2005-158102, for example, which is capable of reproducing and recording information on all types of a high density DVD, a DVD and a CD. In this optical pickup, a spherical aberration of a laser beam emitted from the laser diode LD 1 for high density DVD is corrected by a liquid crystal element LCD, and a comatic aberration of the same is corrected by an insulator substrate SUB, before the laser beam is condensed by an objective lens OBL on the disk. The laser beam is reflected by the disk and is received by a photo detector S1. Furthermore, spherical aberrations of laser beams emitted from a laser diode LD2 for DVD and a laser diode LD3 for CD are corrected by the liquid crystal element LCD, and comatic aberrations of the same are corrected by the insulator substrate SUB, before the laser beams are condensed by the objective lens OBL on the disk. The laser beams are reflected by the disk and are received by a photo detector S2. Then, a reproduction signal, a tracking error signal and a focus error signal are detected based on output signals of the photo detectors S1 and S2. An actuator ACT drives the objective lens OBL based on the detected tracking error signal and the detected focus error signal, so that a tracking servo and a focus servo are preformed.

However, the optical pickup described above has a problem as described below. It is considered that the optical pickup utilizes a so-called push-pull method for detecting the tracking error signal. In the push-pull method, a light receiving surface of a photo detector is divided into two areas as shown in FIG. 6, and the tracking error signal is detected based on a difference between output signals from the detected light receiving surfaces. In the tracking servo, the objective lens is driven by the actuator to shift in the radial direction of the disk. FIG. 6B shows a state where an optical axis of the objective lens is not shifted from an optical axis of the laser beam, and the beam spot is located at the center of the light receiving surface. In this case, if the beam spot is located on the center of a track on the disk, the output signals of the light receiving surfaces are equal to each other so that the tracking error signal is zero. However, if the objective lens is shifted by the actuator, the beam spot is shifted from the center of the light receiving surface as shown in FIG. 6A or FIG. 6C. In this case, even if the beam spot is located on the center of the track on the disk, the output signals of the light receiving surfaces are not equal to each other so that the tracking error signal is not zero. This is the state where a so-called offset of the tracking error signal is generated, and this offset causes a tracking error that the beam spot follows a position shifted from the center of the track, resulting in a bad influence to reproducing and recording information.

### SUMMARY OF THE INVENTION

An object of the present invention is to provide an optical pickup that can produce the tracking error signal with little offset and provide high quality of reproducing and recording information.

An optical pickup according to an aspect of the present invention includes a light source, an objective lens for condensing a light beam emitted from the light source on a disk, a splitting element for splitting the light beam reflected by the disk, a light receiving element for receiving the split light beam, a holding element for holding the objective lens and the splitting element, and a driving element for driving the holding element, the objective lens and the splitting element as one unit to shift in a tracking direction. The splitting element is preferably a hologram element, for example.

According to this structure, even if the objective lens is shifted in the tracking direction, the tracking error signal hardly contains an offset. Thus, the light beam constantly follows a tack on the disk, and high quality of reproducing and recording information can be obtained.

In a preferred embodiment of the present invention, the holding element includes a liquid crystal element and a liquid crystal drive IC for driving the liquid crystal element. According to this structure, the number of drive signals supplied from the liquid crystal drive IC to the liquid crystal element can be the maximum number available without being limited, so that the liquid crystal element can be driven precisely for correcting aberrations generated on the disk.

In another preferred embodiment of the present invention, the holding element includes a liquid crystal element and a wavelength selective aperture. According to this structure, even if the objective lens is shifted in the tracking direction when the spherical aberration generated on the disk is corrected by the liquid crystal element, the comatic aberration is hardly generated on the disk.

As described above, according to the optical pickup of the present invention, the tracking error signal hardly contain an offset so that high quality of reproducing and recording information can be obtained.

### BRIEF DESCRIPTION OF THE DRAWINGS

FIG. 1 shows a general structure of an optical pickup that supports recording and reproducing information on BD, DVD and CD according to an embodiment of the present invention.

FIG. 2 shows a correspondence between hologram surfaces of a hologram element and beam spots on light receiving surfaces of the photo detector in the case where a hologram surface of a hologram element is divided into two areas.

FIGS. 3A-3C show schematically examples of beam spots on the light receiving surfaces in different focus states of a laser beam on a recording surface of the disk.

FIGS. 4A-4C show schematically examples of beam spots on the light receiving surface for detecting the tracking error signal in different shift positions of an objective lens for BD in the tracking direction.

FIG. 5A shows input and output signals of a liquid crystal drive IC.

FIG. 5B shows a method of supplying signals via suspension wires to components mounted on a conventional lens holder.

FIG. 5C shows a method of supplying signals via suspension wires to components mounted on a lens holder according to the embodiment of the present invention and supplying signals from the liquid crystal drive IC to a liquid crystal element.

FIG. 6A-6C show beam spots on the light receiving surface in different shift positions of the objective lens in the tracking direction according to the conventional method.

### DESCRIPTION OF THE PREFERRED EMBODIMENTS

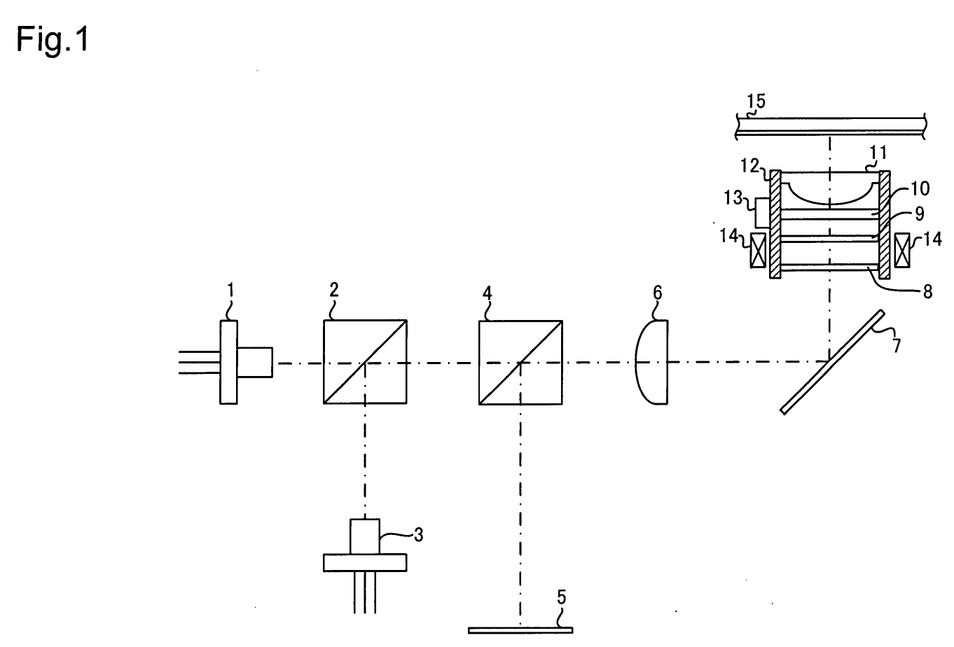

Now, an embodiment of the present invention will be described with reference to the attached drawings. FIG. 1 shows a general structure of an optical pickup that supports recording and reproducing information on BD (Blu-ray Disc), DVD and CD according to an embodiment of the present invention.

This optical pickup includes a laser diode 1 for BD, a dichroic prism 2, laser diode 3 for DVD and CD, a polarizing beam splitter 4, a photo detector 5, a collimator lens 6, a mirror 7, a hologram element 8, a wavelength selective aperture 9, a liquid crystal element 10, an objective lens 11 for BD, a lens holder 12, a liquid crystal drive IC 13 and an actuator 14.

Together with the objective lens 11 for BD, the hologram element 8, the wavelength selective aperture 9, the liquid crystal element 10 and the liquid crystal drive IC 13 are mounted on the lens holder 12. The lens holder 12 is retained by a pickup base (not shown) via a plurality of suspension wires (not shown). The actuator 14 is made up of a focus coil and a tracking coil (not shown) attached to the lens holder 12 and a magnet (not shown) attached to the pickup base. The focus coil and the tracking coil are provided with drive current via the suspension wires.

When information is reproduced or recorded on the BD, the laser diode 1 for BD emits a blue color laser beam having a wavelength of 405 nm. The blue color laser beam emitted from the laser diode 1 for BD passes through the dichroic prism 2 and the polarizing beam splitter 4 in turn, enters the collimator lens 6, and goes out from the collimator lens 6 as parallel rays.

The blue color laser beam that is parallel rays going out from the collimator lens 6 is reflected by the mirror 7, passes through the hologram element 8, and enters the wavelength selective aperture 9. The wavelength selective aperture 9 restricts an aperture in accordance with a wavelength but permits the blue color laser beam to pass through. The blue color laser beam that has passed the wavelength selective aperture 9 enters the liquid crystal element 10. The liquid crystal element 10 is supplied with a voltage from the liquid crystal drive IC 13 and changes a wavefront of a passing laser beam. In this case, the liquid crystal element 10 is not supplied with a voltage and permits the blue color laser beam to pass through. The blue color laser beam that has passed the liquid crystal element 10 enters the objective lens 11 for BD. Then, the blue color laser beam is condensed by the objective lens 11 for BD with a numerical aperture of 0.85 on a recording surface of a disk 15 after passing through a cover layer (having a thickness of 0.1 mm).

The blue color laser beam reflected by a recording layer of the disk 15 passes through the objective lens 11 for BD, the liquid crystal element 10, the wavelength selective aperture 9 in turn and is split by the hologram element 8. The split blue color laser beam is reflected by the mirror 7 so that its optical path is bent and passes through the collimator lens 6. Then, the blue color laser is reflected by the polarizing beam splitter 4 so that its optical path is bent and is condensed on a light receiving surface of the photo detector 5.

A reproduction signal, a focus error signal and a tracking error signal are generated from an output signal of the photo detector 5. Then, the actuator 14 drives the lens holder 12 together with the objective lens 11 for BD, the hologram element 8, the wavelength selective aperture 9, the liquid crystal element 10 and the liquid crystal drive IC 13 to move in a focus direction (that is perpendicular to a disk surface) and in a tracking direction (in the radial direction of the disk) based on the focus error signal and the tracking error signal, so that a focus servo and a tracking servo are performed.

Next, when information is reproduced or recorded on the DVD, the laser diode 3 for DVD and CD emits red color laser beam having a wavelength of 650 nm. The red color laser beam emitted from the laser diode 3 for DVD and CD is reflected by the dichroic prism 2 so that its optical path is bent, passes through the polarizing beam splitter 4, enters the collimator lens 6, and goes out from the collimator lens 6 as parallel rays.

The red color laser beam that is parallel rays going out from the collimator lens 6 is reflected by the mirror 7, passes through the hologram element 8, and enters the wavelength selective aperture 9. The wavelength selective aperture 9 restricts an aperture of the passing red color laser beam to a numerical aperture of 0.6. The red color laser beam that has passed through the wavelength selective aperture 9 enters the liquid crystal element 10. The liquid crystal element 10 is supplied with a voltage from the liquid crystal drive IC 13 and changes a wavefront of the passing red color laser beam, so that a spherical aberration on the recording surface of the disk 15 due to a difference between laser wavelengths of the BD and the DVD and a difference of the cover layer thicknesses of the disks is corrected.

The red color laser beam that has passed through the liquid crystal element 10 enters the objective lens 11 for BD. Then, the red color laser beam is condensed by the objective lens 11 for BD with a numerical aperture of 0.6 on the recording surface of the disk 15 after passing through the cover layer (having a thickness of 0.6 mm) of the same.

The red color laser beam is reflected by the recording surface of the disk 15, passes through the objective lens 11 for BD, the liquid crystal element 10 and the wavelength selective aperture 9 in turn, and is split by the hologram element 8. The split red color laser beam is reflected by the mirror 7, passes through the collimator lens 6, is reflected by the polarizing beam splitter 4 so that its optical path is bent, and is condensed on the light receiving surface of the photo detector 5.

In the same way as the above-mentioned case of the BD, the reproduction signal, the focus error signal and the tracking error signal are generated from an output signal of the photo detector 5, so that the focus servo and the tracking servo are performed.

Next, when information is reproduced or recorded on the CD, the laser diode 3 for DVD and CD emits an infrared laser beam having a wavelength of 780 mn. The infrared laser beam emitted from the laser diode 3 for DVD and CD is reflected by the dichroic prism 2 so that its optical path is bent, passes through the polarizing beam splitter 4, enters the collimator lens 6, and goes out from the collimator lens 6 as parallel rays.

The infrared laser beam that is parallel rays going out from the collimator lens 6 is reflected by the mirror 7, passes through the hologram element 8, and enters the wavelength selective aperture 9. The wavelength selective aperture 9 restricts an aperture of the passing infrared laser beam to a numerical aperture of 0.45. The infrared laser beam that has passed through the wavelength selective aperture 9 enters the liquid crystal element 10. The liquid crystal element 10 is supplied with a voltage from the liquid crystal drive IC 13 and changes a wavefront of the passing infrared laser beam, so that a spherical aberration on the recording surface of the disk 15 due to a difference between laser wavelengths of the BD and the CD and a difference between cover layer thicknesses of the disks is corrected.

The infrared laser beam that has passed through the liquid crystal element 10 enters the objective lens 11 for BD. Then, the infrared laser beam is condensed on by objective lens 11 for BD with a numerical aperture of 0.45 on the recording surface of the disk 15 after passing through the cover layer (having a thickness of 1.2 mm) of the same.

The infrared laser beam reflected by the recording surface of the disk 15 passes through the objective lens 11 for BD, the liquid crystal element 10 and the wavelength selective aperture 9 in turn and is split by the hologram element 8. The split infrared laser beam is reflected by the mirror 7 so that its optical path is bent, passes through the collimator lens 6, is reflected by the polarizing beam splitter 4 so that its optical path is bent, and is condensed on the light receiving surface of the photo detector 5.

In the same way as the above-mentioned case of the BD, the reproduction signal, the focus error signal and the tracking error signal are generated from an output signal of the photo detector 5, so that the focus servo and the tracking servo are performed.

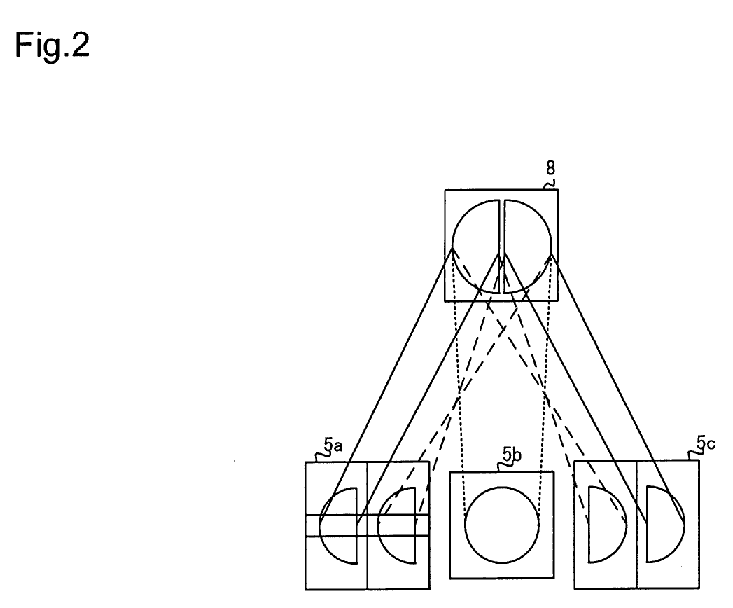

As described above, the hologram element 8 splits the reflected light from the disk 15. FIG. 2 shows a correspondence between hologram surfaces and beam spots on light receiving surfaces of the photo detector 5 in the case where a hologram surface of the hologram element 8 is divided into two areas. The photo detector 5 includes a light receiving surface 5a for detecting the focus error signal, a light receiving surface 5b for detecting the reproduction signal and a light receiving surface 5c for detecting the tracking error signal. Two semicircular beam spots are formed on each of the light receiving surface 5a and the light receiving surface 5c by the laser beams diffracted by the hologram surfaces. In addition, one circular beam spot is formed on the light receiving surface 5b by the laser beam diffracted by the hologram surfaces.

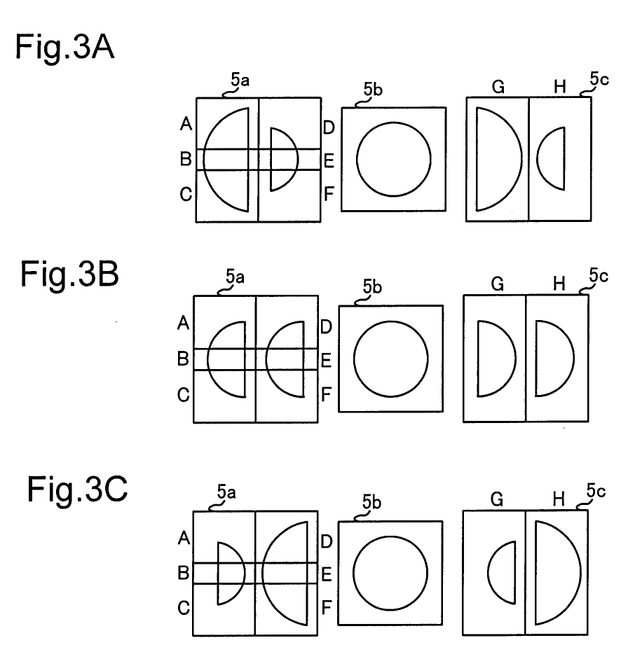

FIGS. 3A-3C show schematically examples of beam spots on the light receiving surfaces in different focus states of the laser beam on the recording surface of the disk. FIG. 3A shows a state where the disk 15 is close to the objective lens 11 for BD, FIG. 3B shows a state where the laser beam is focused on the recording surface of the disk 15, and FIG. 3C shows a state where the disk 15 is distant from the objective lens 11 for BD.

As shown in FIGS. 3A-3C, the six split areas of the light receiving surface Sa are represented by A, B, C, D, E and F. When the focus state transfers from the state of FIG. 3A to the state of FIG. 3C via the state of FIG. 3B, a size of the semicircular beam spot formed in the area A, B or C is decreased. On the contrary, a size of the semicircular beam spot formed in the area D, E or F is increased. In the focused state of FIG. 3B, the sizes of the left and the right semicircular beam spots are equal to each other. A focus error signal FE is expressed by the equation FE=(SA+SC−SB)−(SD+SF−SE), where SA, SB, SC, SD, SE and SF denote output signals (light reception quantities) of the areas A, B, C, D, E and F, respectively. In the state of FIG. 3A, FE>0 holds. In the state of FIG. 3B, FE=0 holds. In the state of FIG. 3C, FE<0 holds.

Furthermore, as shown in FIGS. 3A-3C, two split areas of the light receiving surface 5c are denoted by G and H. When the focus state transfers from the state of FIG. 3A to the state of FIG. 3C via the state of FIG. 3B, a size of the semicircular beam spot formed in the area G is decreased. On the contrary, a size of the semicircular beam spot formed in the area H is increased. In the focused state of FIG. 3B, the sizes of the left and the right semicircular beam spots are equal to each other. A tracking error signal TE is expressed by the equation TE=SG−SH, where SG and SH denote output signals (light reception quantities) of the areas G and H, respectively. When the beam spot is located in the center of the track on the disk 15, TE>0 holds in FIG. 3A, TE=0 holds in FIG. 3B, and TE<0 holds in FIG. 3C. Thus, the focus servo is performed, and the tracking error signal becomes a correct value when the laser beam is focused on the disk recording surface as shown in FIG. 3B.

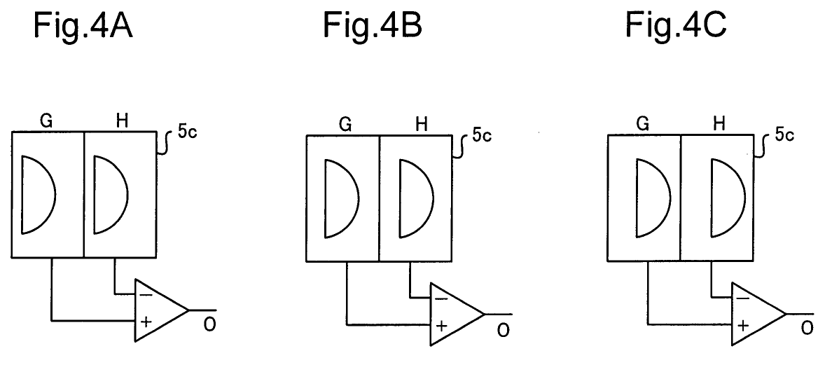

During the time period while the tracking servo is performed, the objective lens 11 for BD is driven to shift in the tracking direction. FIGS. 4A-4C show schematically examples of beam spots on the light receiving surface for detecting the tracking error signal 5c in different shift positions of an objective lens for BD in the tracking direction. FIG. 4B shows the sate where the laser beam is focused on the disk recording surface by the focus servo, and the beam spot is positioned at the center of a track on the disk so that an optical axis of the objective lens 11 for BD is not shifted from an optical axis of the laser beam. In this case, the tracking error signal TE becomes zero. FIGS. 4A and 4C show the states where the objective lens 11 for BD is shifted by the tracking servo in the tracking direction, so that an optical axis of the objective lens 11 for BD is shifted from an optical axis of the laser beam. Since the hologram element 8 is mounted on the lens holder 12 together with the objective lens 11 for BD as described above, the hologram element 8 is also shifted in the same way as the objective lens 11 for BD so that the semicircular beam spots on the light receiving surface 5c are shifted on the light receiving surfaces of the areas (G, H) without changing the shapes. Therefore, if the beam spot is positioned at the center of the track on the disk in the state of FIG. 4A or FIG. 4C, a state in valance of the output signals from the left and the right light receiving surfaces can be obtained so that the tracking error signal TE becomes zero without an offset. Thus, the laser beam follows the track constantly, and quality of reproducing and recording information is improved.

Furthermore, in the optical pickup of the present embodiment, the liquid crystal element 10 and the liquid crystal drive IC 13 are mounted on the lens holder 12. The liquid crystal element 10 includes a liquid crystal material and electrodes sandwiching the liquid crystal material. A zone plate pattern is formed on at least one of the electrodes. When a voltage is applied to the electrodes, a wavefront of the laser beam passing through the liquid crystal element 10 is changed. Thus, a spherical aberration of the laser beam can be corrected, which is generated on the disk recording surface when information is reproduced or recorded on the DVD or the CD.

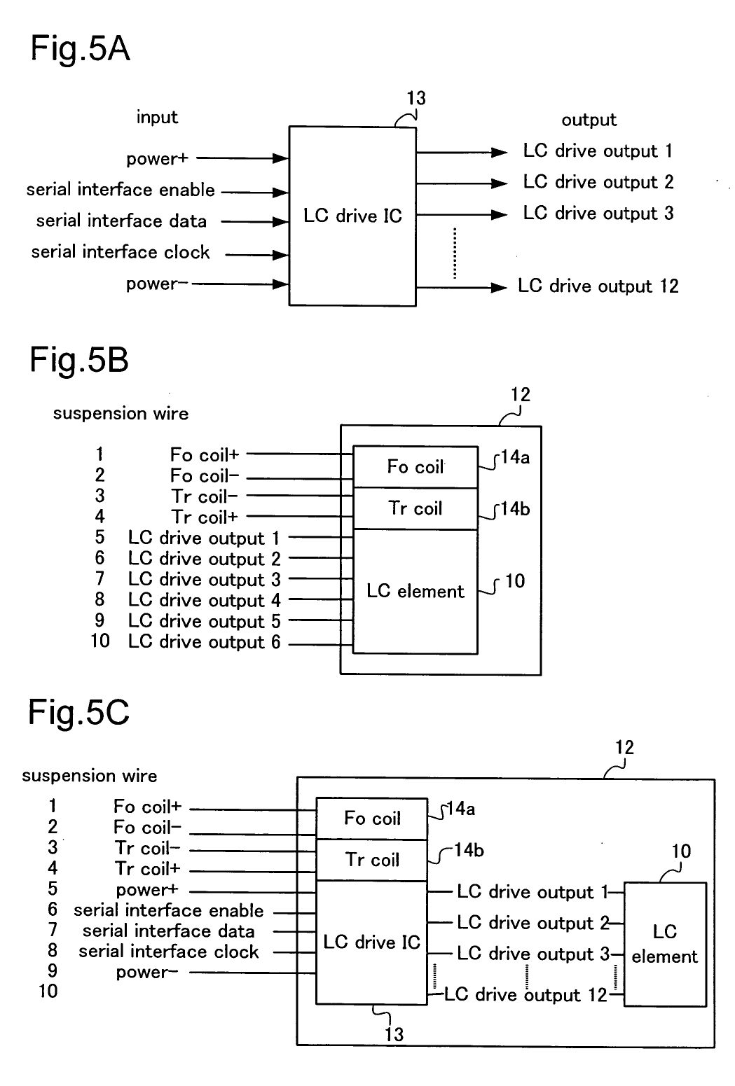

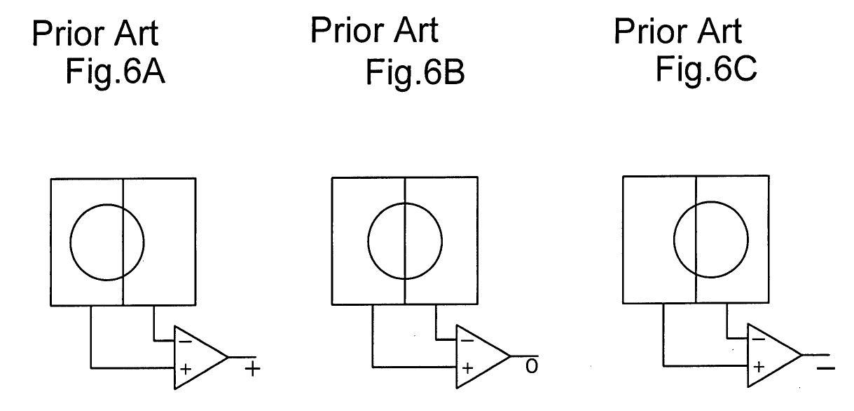

In addition, the liquid crystal drive IC 13 inputs five input signals and outputs twelve output signals at most for driving the liquid crystal element 10 as shown in FIG. 5A, and the output signals are supplied to the electrodes of the liquid crystal element 10. In the conventional structure, the liquid crystal drive IC 13 is mounted on the pickup base, so components mounted on the lens holder 12 are supplied with signal from the liquid crystal drive IC 13 or the like on the pickup base side. The situation in this case is shown in FIG. 5B. As described above, the lens holder 12 is retained by the pickup base via the suspension wires. A focus coil 14a and a tracking coil 14b mounted on the lens holder 12 are supplied with two drive signals each (total four signals) from the pickup base via the suspension wires. Since a space is limited, the number of the suspension wires is limited. If the number of the suspension wires is limited to ten at most, the number of output signals for driving the liquid crystal element 10 that can supplied from the liquid crystal drive IC 13 mounted on the pickup base to the liquid crystal element 10 mounted on the lens holder 12 via the suspension wire is limited to six (10−4) at most.

In contrast, according to the structure of the embodiment of the present invention, the liquid crystal drive IC 13 is mounted on the lens holder 12. The situation of signal supply in this case is shown in FIG. 5C. In the same way as the conventional structure described above, the focus coil 14a and the tracking coil 14b mounted on the lens holder 12 are supplied with two drive signals each (total four signals) from the pickup base via the suspension wires. Five of the remaining six suspension wires are used for supplying input signals of the liquid crystal drive IC 13 mounted on the lens holder 12 from the pickup base. Then, the liquid crystal element 10 mounted on the lens holder 12 can be supplied with twelve output signals for driving the liquid crystal element 10 from the liquid crystal drive IC 13 via a flexible circuit board or the like. In this way, according to the structure of the present embodiment, since the liquid crystal drive IC 13 is mounted on the lens holder 12, the number of the output signals for driving the liquid crystal element 10 supplied to the same is not limited despite of the limitation of the number of the suspension wires unlike the conventional structure. All the output signals for driving the liquid crystal element 10 that can be outputted from the liquid crystal drive IC 13 can be used. Thus, a wavefront of the laser beam passing through the liquid crystal element 10 can be changed more precisely for correcting the spherical aberration.

In addition, according to the structure of the present invention, the liquid crystal element 10 and the wavelength selective aperture 9 are mounted on the lens holder 12. Thus, when information is reproduced or recorded on the DVD or the CD for which the liquid crystal element 10 and the wavelength selective aperture 9 work, a comatic aberration of the laser beam is hardly generated on the disk recording surface because the liquid crystal element 10 and the wavelength selective aperture 9 are shifted together with the objective lens 11 for BD when it is shifted in the tracking direction by the tracking servo.

What is claimed is:

1. An optical pickup, comprising:
a light source;
an objective lens for condensing a light beam emitted from the light source on a disk;
a splitting element for splitting the light beam reflected by the disk;
a light receiving element for receiving the split light beam;
a holding element for holding the objective lens and the splitting element; and
a driving element for driving the holding element, the objective lens and the splitting element as one unit to shift in a tracking direction.

2. The optical pickup according to claim 1, wherein the splitting element is a hologram element.

3. The optical pickup according to claim 1, wherein the holding element includes a liquid crystal element and a liquid crystal drive IC for driving the liquid crystal element.

4. The optical pickup according to claim 1, wherein the holding element includes a liquid crystal element and a wavelength selective aperture.

5. The optical pickup according to claim 2, wherein the holding element includes a liquid crystal element and a liquid crystal drive IC for driving the liquid crystal element.

6. The optical pickup according to claim 2, wherein the holding element includes a liquid crystal element and a wavelength selective aperture.

7. The optical pickup according to claim 3, wherein the holding element includes a wavelength selective aperture.

8. The optical pickup according to claim 5, wherein the holding element includes a wavelength selective aperture.
